(19) United States
(12) Patent Application Publication
(10) Pub. No.: US 2019/0353543 A1
(43) Pub. Date: Nov. 21, 2019

(54) AXIAL THRUST FORCE BALANCING APPARATUS FOR AN INTEGRALLY GEARED COMPRESSOR

(71) Applicant: Hanwha Power Systems Co., Ltd., Changwon-si (KR)

(72) Inventor: Jonathan BYGRAVE, Houston, TX (US)

(73) Assignee: Hanwha Power Systems Co., Ltd., Changwon-si (KR)

(21) Appl. No.: 15/985,067

(22) Filed: May 21, 2018

(51) Int. Cl. G01L 5/12; F04D 29/051; F04D 29/057; F16C 32/06

(52) U.S. Cl. CPC G01L 5/12; F16C 32/0692; F04D 29/057; F04D 29/0513

(57) ABSTRACT

An apparatus for adjusting an axial thrust force acting on a rotor of an integrally geared compressor (IGC) is provided. In the present disclosure, the axial thrust force acting on the rotor of the IGC may be adjusted in two opposite directions by tandem seals having different effective sealing diameters, and a thrust force generated in compressors located at both sides of a gear may be effectively offset. Furthermore, since a thrust load acting on the rotor of the IGC is offset, an operating pressure level at which the IGC operates may be increased.

### BACKGROUND

### 1. Field

Example embodiments of the present disclosure relate to an integrally geared compressor (IGC), and more particularly, to an apparatus for adjusting an axial thrust force generated in an IGC in two opposite directions and an IGC including the same.

### 2. Description of the Related Art

During operation of a compressor, gas pressure acts on a surface of a centrifugal flow impeller. Gas pressure acting on a surface of an impeller generates a thrust force. The thrust force acts on a rotor of the compressor in an axial direction. The gas pressure also acts on a shaft and a seal. Several different types of seals may be used for a centrifugal compressor, and each of the seals applies an axial force to a rotor. As a result, the magnitude of an axial thrust load applied to the rotor may change according to the shape of the impeller, the diameter of the shaft, the seal, and local pressure around each component.

Also, since the pressure profile of the compressor is changed according to an operation map, the axial thrust load applied to the rotor may vary accordingly. The range in which the axial thrust load varies may be further increased as the operating pressure level of the compressor is increased.

A thrust bearing is used to offset an unbalanced axial thrust load. Generally, in an in-line compressor, a thrust balance disk is used to offset an axial thrust load. When the thrust balance disk and the thrust bearing are used together, a thrust bearing having a relatively small size may be employed.

Generally, an integrally geared compressor (IGC) does not include a thrust balance disk. When a thrust balance disk is mounted in an IGC, the thrust balance disk may need to be disposed outside a journal bearing, which can cause considerable difficulty in designing for satisfactory rotor dynamics. Therefore, in an IGC, in order to reduce or minimize an axial thrust load transmitted to a thrust bearing of a gear box, thrust force needs to be managed at each stage of the compressor.

However, since the range in which a pressure varies is increased when the operating pressure level of the IGC is increased, balance of the overall axial thrust load on the rotor may not be achieved under all operating conditions. This limits the range in which the IGC may operate and may make it difficult for the IGC to operate at a high pressure at which an in-line compressor may operate.

Therefore, example embodiments of the present disclosure provide an apparatus and a compressor capable of adjusting and balancing an axial thrust force.

### SUMMARY

One or more example embodiments of the present disclosure provide a method of adjusting and balancing an axial thrust force acting on a rotor of an integrally geared compressor (IGC). Specifically, the present disclosure provides a method of adjusting an axial thrust force acting on a rotor in two opposite directions caused by compressor stages located at two opposite sides of a gear applying a thrust force to an IGC in two opposite directions, respectively.

According to an aspect of an example embodiment, there is provided an axial thrust force balancing apparatus for a compressor including a rotor including a pinion gear configured to receive rotational power from a bull gear, a first shaft disposed at one side of the pinion gear and configured to communicate with the pinion gear, a second shaft disposed at the other side of the pinion gear and configured to communicate with the pinion gear, a first rotating body disposed at one end of the first shaft and configured to communicate with the first shaft, and a second rotating body disposed at one end of the second shaft and configured to communicate with the second shaft, and a first sealing device including tandem seals configured to surround the first shaft in a radial direction, a second sealing device including tandem seals configured to surround the second shaft in a radial direction, and a control device configured to adjust a pressure in a space between the tandem seals of the first sealing device and a pressure in a space between the tandem seals of the second sealing device, and balance an axial thrust force acting on the rotor in two opposite directions.

The control device may be further configured to adjust the pressure in the space between the tandem seals of the first sealing device and the pressure in the space between the tandem seals of the second sealing device based on an axial position of the rotor.

The axial thrust force balancing apparatus may further include a sensor configured to measure the axial position of the rotor.

The axial thrust force balancing apparatus may further include two thrust collars disposed at two opposite sides of the pinion gear and respectively disposed adjacent to the first shaft and the second shaft, wherein the sensor may be further configured to measure an axial position of any one of the two thrust collars, and measure the axial position of the rotor based on the measured axial position of any one of the two thrust collars.

The control device may be further configured to independently adjust the pressure in the space between the tandem seals of the first sealing device and the pressure in the space between the tandem seals of the second sealing device.

The tandem seals of the first sealing device may be configured as tandem seals with different effective sealing diameters, and the tandem seals of the second sealing device may be configured as tandem seals with different effective sealing diameters.

The first sealing device and the second sealing device may include the same number of seals.

The seals included in the first sealing device and the second sealing device, respectively, may include a rotating part and a non-rotating part, and the rotating part may include a groove configured to compress gas and maintain a gap between the rotating part and the non-rotating part.

The tandem seals of the first sealing device may include a first seal configured to firstly seal process gas introduced from the first rotating body and a second seal configured to secondarily seal the process gas, and the tandem seals of the second sealing device may include a third seal configured to firstly seal process gas introduced from the second rotating body and a fourth seal configured to secondarily seal the process gas.

The axial thrust force balancing apparatus, wherein an effective sealing diameter of the first seal may be different from an effective sealing diameter of the second seal, and an effective sealing diameter of the third seal may be different from an effective sealing diameter of the fourth seal.

The effective sealing diameter of the first seal may be greater than the effective sealing diameter of the second seal, and the effective sealing diameter of the third seal may be greater than the effective sealing diameter of the fourth seal.

The effective sealing diameter of the first seal may be equal to the effective sealing diameter of the third seal, and the effective sealing diameter of the second seal may be equal to the effective sealing diameter of the fourth seal.

The control device may be further configured to adjust a pressure in a space between the first seal and the second seal and a pressure in a space between the third seal and the fourth seal.

The control device may be further configured to independently adjust the pressure in the space between the first seal and the second seal and the pressure in the space between the third seal and the fourth seal.

The axial thrust force balancing apparatus, wherein a first axial thrust force F1 is formed according to F1=(P1−P2)×A1−(A1−A2)×P12, where A1 is an area within an effective sealing diameter of the first seal, A2 is an area within an effective sealing diameter of the second seal, P1 is a pressure in a space sealed by the first seal, P12 is a pressure in a space sealed by the second seal, and P2 is a pressure in a space separated from the sealed space by the second seal, and a second axial thrust force F2 is formed according to F2=(P3−P4)×A3−(A3−A4)×P34, where A3 is an area within an effective sealing diameter of the third seal, A4 is an area within an effective sealing diameter of the fourth seal, P3 is a pressure in a space sealed by the third seal, P34 is a pressure in a space sealed by the fourth seal, and P4 is a pressure in a space separated from the sealed space by the fourth sea, wherein the control device is configured to adjust P12 and P34 and adjust F1 and F2 based on the adjusted P12 and P34.

The axial thrust force balancing apparatus, wherein each of the first sealing device and the second sealing device may be configured as at least one of a dry gas seal, a labyrinth seal, and a floating seal.

The rotor may further include a first stage compressor disposed at one end of the first rotating body and a second stage compressor disposed at one end of the second rotating body, and the control device may be further configured to balance the axial thrust force acting on the rotor in two opposite directions by the first stage compressor and the second stage compressor

### BRIEF DESCRIPTION OF THE DRAWINGS

The above and other aspects and features, features, and advantages of certain embodiments of the present disclosure will become more apparent and readily appreciated by the following example embodiments, taken in conjunction with the accompanying drawings, in which:

FIG. 1 is a perspective view illustrating an integrally geared compressor (IGC) according to an example embodiment;

FIG. 2 is a view illustrating an impeller of a first-stage compression unit for taking in process gas according to an example embodiment;

FIG. 3 is a view illustrating an effective sealing diameter of a dry gas seal according to an example embodiment;

FIG. 4 is a view illustrating a first sealing device according to an example embodiment; and

FIG. 5 is a view illustrating a system for adjusting and balancing an axial thrust force acting on a rotor in an IGC in two opposite directions according to an example embodiment.

### DETAILED DESCRIPTION

Advantages and features of the present disclosure and methods of achieving the same will be clearly understood with reference to the accompanying drawings and the following detailed embodiments. However, the present disclosure is not limited to the example embodiments to be disclosed, but may be implemented in various different forms. The example embodiments are provided in order to fully explain the present disclosure and fully explain the scope of the present disclosure for those skilled in the art. The scope of the present disclosure is defined by the appended claims Like reference numerals principally refer to like elements throughout the specification.

Unless otherwise defined, all terms (including technical and scientific terms) used herein can be used as is customary in the art to which this disclosure belongs. Also, It will be further understood that terms, such as those defined in commonly used dictionaries, will not be interpreted in an idealized or overly formal sense unless expressly so defined herein.

The terms used herein are provided to only describe example embodiments of the present disclosure and not for purposes of limitation. Unless the context clearly indicates otherwise, the singular forms include the plural forms. It will be understood that the terms “comprise” or “comprising” when used herein, specify some stated components, steps, operations and/or elements, but do not preclude the presence or addition of one or more other components, steps, operations and/or elements.

As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, example embodiments of the disclosure will be described in detail with reference to the accompanying drawings.

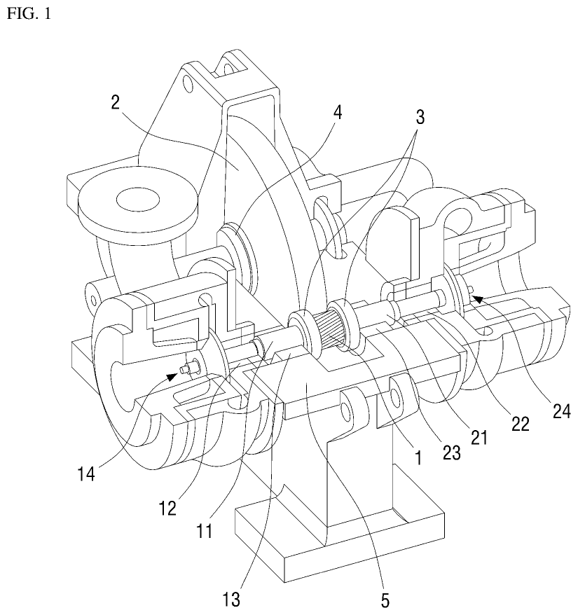

FIG. 1 is a perspective view of an integrally geared compressor (IGC) according to an example embodiment. The IGC may include a pinion gear 1, a bull gear 2, thrust collars 3, a thrust bearing 4, a housing 5, a first shaft 11, a first sealing device 12, a first bearing 13, a first-stage compression unit 14, a second shaft 21, a second sealing device 22, a second bearing 23, a second-stage compression unit 24, a control device, and a sensor. The pinion gear 1, the first shaft 11, and the second shaft 21 may be formed integrally.

The IGC is operated by the bull gear in multiple stages. In FIG. 1, an IGC including a first-stage compression unit and a second-stage compression unit is illustrated. However, example embodiments are not limited thereto, and the IGC according to the present disclosure may include additional compression unit stages.

The bull gear 2 is a gear configured to provide rotational power so the first-stage compression unit 14 and the second-stage compression unit 24 can compress process gas. The rotational power generated in the bull gear 2 is transmitted to the pinion gear 1 in communication with the bull gear 2.

The bull gear 2 and the pinion gear 1 may be configured as, for example, helical gears, double-helical gears or spur gears. The bull gear and the pinion gear may be configured as helical gears or double-helical gears in order to reduce friction on a contact surface therewith.

The rotational power transmitted to the pinion gear 1 is transmitted to the first-stage compression unit 14 along the first shaft 11 located at one side of the pinion gear 1 and is transmitted to the second-stage compression unit 24 along the second shaft 21 located at the other side of the pinion gear 1 opposite to the first stage compression unit 14.

The first-stage compression unit 14 may include an impeller, a diffuser, a shroud, and a scroll. The rotational power transmitted to the first-stage compression unit 14 is used to rotate the impeller. The impeller may rotate at a relatively high speed and intake the process gas. The diffuser may slowly reduce the speed of the process gas taken in by the impeller and convert the speed of the process gas being reduced into an increased pressure. The process gas, which is pressurized by the impeller and the diffuser, flows out along the scroll. The shroud is coupled to the scroll to form a space in which the impeller and the diffuser are accommodated.

The second-stage compression unit 24 may include an impeller, a diffuser, a shroud, and a scroll similar to the first-stage compression unit 14. Further, the gas compression principle of the second-stage compression unit 24 may be the same as that of the first-stage compression unit 14.

The pinion gear 1, the thrust collars 3, the first shaft 11, the second shaft 21, the rotating part of the first seal 12, the rotating part of the second seal 22, the impeller of the first-stage compression unit 14, and the impeller of the second-stage compression unit 24, which are rotated by the rotational power of the bull gear 2 may constitute a rotor.

The first bearing 13 supports a radial thrust load of the first shaft 11 so the first shaft 11 may more easily rotate while in communication with the pinion gear 1. Similarly, the second bearing 23 supports a radial thrust load of the second shaft 21 so the second shaft 21 may more easily rotate while in communication with the pinion gear 1.

The first bearing 13 and the second bearing 23 may be configured as journal bearings to support the radial loads of the first shaft 11 and the second shaft 21, respectively. Further, the first bearing 13 and the second bearing 23 may be configured as tilting pad journal bearings to support the first shaft 11 and the second shaft 21, respectively, which rotate at a higher speed. When the first bearing 13 and the second bearing 23 are configured as tilting pad journal bearings, a tilting pad journal bearing using a rocker-back pivot method or a tilting pad journal bearing using a ball-socket pivot method may be used.

The first sealing device 12 may include tandem seals which block process gas leaking along a gap in the housing 5 without flowing from the first-stage compression unit 14 into the scroll. Similarly, the second sealing device 22 may include tandem seals which block process gas leaking from the second-stage compression unit 24. Blocking the leaking process gas is needed because oil is usually used for lubrication in the first bearing 13, the second bearing 23, the pinion gear 1, and the bull gear 2.

The tandem seals included in the first sealing device 12 and the second sealing device 22 may be configured as dry gas seals. The dry gas seal is a seal which uses dry gas instead of sealing oil. The dry gas seal may include a fixed part and a rotating part, and a specially formed groove which can be formed in the rotating part. The specially formed groove may locally compress the dry gas by rotation to maintain a gap between the fixed part and the rotating part. At the gap between the fixed part and the rotating part, a pressure in the dry gas is kept higher than that of the process gas to reduce or minimize leakage of the process gas.

In addition to the dry gas seal, various types of separation seals such as, for example, a labyrinth seal, a floating seal, and the like may be used for the tandem seals included in the first sealing device 12 and the second sealing device 22. A labyrinth seal, along with the tandem seals, may be used for the first sealing device 12 and the second sealing device 22.

The thrust collars 3 are configured to absorb an axial thrust load of a rotor. A hydrodynamic pressure may act on thin films between the thrust collars 3 and the bull gear 2, and the thrust collars 3 may absorb the axial thrust load being applied to the rotor by the hydrodynamic pressure. That is, the thrust collar 3 may serve as a hydrodynamic bearing which transmits the axial thrust load to the bull gear 2. Alternatively, the thrust collars may transfer the axial thrust load on the pinion gear 1 directly to high speed thrust bearings 4 instead of to the bull gear 2.

The thrust bearing 4 is configured to support the axial thrust load transmitted to the bull gear 2 by the pinion gear 1. The thrust bearing 4 may be configured as a bearing which supports the axial thrust load, such as, for example, a tilting pad thrust bearing, a fixed geometry thrust bearing, or the like.

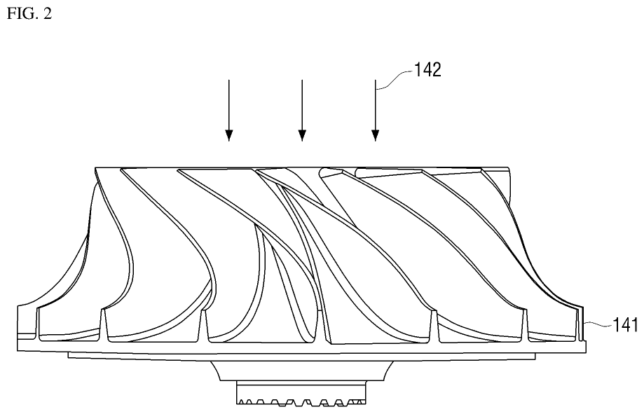

FIG. 2 is a view illustrating an impeller of a first-stage compression unit 14 for taking in process gas according to an example embodiment. An impeller 141 rotates at a relatively high speed and takes in process gas 142. Since the process gas 142 is taken into the impeller 141 in an axial direction, a considerable amount of thrust force is applied to the impeller 141 in the axial direction. Accordingly, an axial thrust load is generated in the impeller 141 by an axial thrust force which is a component in the axial direction of a total resultant force of the pressure load.

A thrust load generated by the process gas in the first-stage compression unit 14 also affects the first shaft 11 in communication with the impeller. A magnitude of the thrust load applied to the first shaft 11 may be determined by a radius of the first shaft. An axial thrust load is applied by the process gas to an impeller of a second-stage compression unit 24 and a second shaft 21 by the same principle.

In an IGC, since the first-stage compression unit 14 and the second-stage compression unit 24 are provided on the opposite side respect to the pinion gear 1, an axial thrust load is generated in the IGC in two opposite directions by the first-stage compression unit 14 and the second-stage compression unit 24. Therefore, in an IGC, the axial thrust load should be adjusted in consideration of both of the first-stage compression unit 14 and the second-stage compression unit 24.

An axial thrust force may also be generated in a first sealing device 12 and a second sealing device 22.

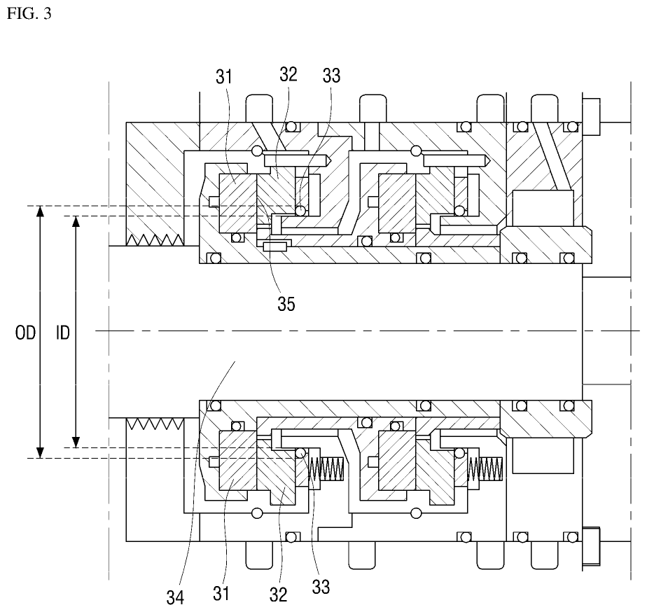

FIG. 3 is a view illustrating an effective sealing diameter of a dry gas seal according to an example embodiment. The dry gas seal includes a rotating member 31 which rotates while in communication with a shaft 34, a non-rotating member 32, and an static seal 33.

The dry gas seal forms a primary sealing surface 35 between the rotating member 31 and the non-rotating member 32. A specially formed groove can be formed in the rotating member 31 so when the rotating member rotates, dry gas may be locally compressed by the specially formed groove and a gap between the rotating member 31 and the non-rotating member 32 is maintained. Since a pressure in the dry gas is maintained relatively high at the primary sealing surface 35, leakage of the gas may be reduced or minimized.

The static seal 33 forms a secondary sealing ring which seals the non-rotating member 32 in the housing. The static seal 33 may become an equilibrium point of the primary sealing surface 35. Therefore, an inner diameter ID of the static seal 33 may be an effective sealing diameter of the dry gas seal. An effective sealing diameter in a dry gas chamber may be in between the inner diameter ID and an outer diameter OD of the static seal 33, but may be the inner diameter ID of the static seal 33.

Based on the above description of the effective sealing diameter, the axial thrust force generated in the first sealing device 12 and the second sealing device 22 will be described. The axial thrust force may be generated in the second sealing device 22 by the same principle as that of the first sealing device 12.

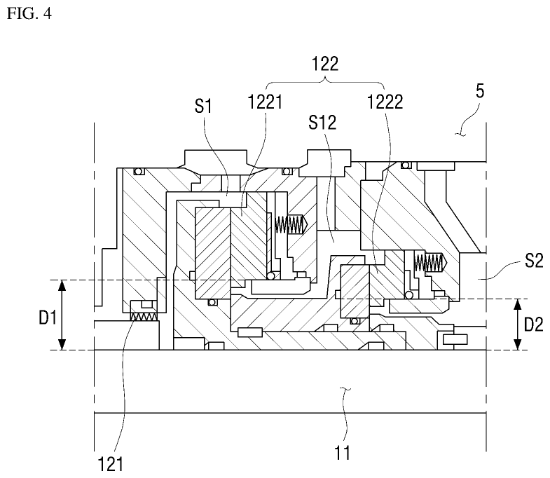

FIG. 4 is a view illustrating the first sealing device 12 according to an example embodiment. The first sealing device 12 includes a process side labyrinth seal 121 and tandem dry gas seals 122.

A plurality of circular sealing strips are sequentially provided on a periphery of a shaft of the labyrinth seal 121 to allow a buffer against the potentially dirty process gas to be formed by injecting clean filtered gas to space S1. The labyrinth seal 121 may be formed at one end of the housing 5, and may be formed not to be brought into contact with the shaft 11 to reduce or prevent friction.

The tandem dry gas seals 122 include a first dry gas seal 1221 which firstly blocks the process gas and a second dry gas seal 1222 which secondarily blocks the process gas.

The first dry gas seal 1221 and the second dry gas seal 1222 may have different effective sealing diameters. Since a distance D1 between the static seal of the first dry gas seal 1221 and the first shaft 11 is greater than a distance D2 between the static seal of the second dry gas seal 1222 and the first shaft 11, an effective sealing diameter of the first dry gas seal 1221 is greater than an effective sealing diameter of the second dry gas seal 1222.

A pressure in a space 51 sealed by the first dry gas seal 1221 is referred to as P1. A pressure in a space S12 sealed by the second dry gas seal 1222 is referred to as P12. A pressure in a space S2 which is separated from the sealed space S12 by the second dry gas seal 1222 is referred to as P2. An area within the effective sealing diameter of the first dry gas seal 1221 is referred to as A1. Finally, an area within the effective sealing diameter of the second dry gas seal 1222 is referred to as A2.

When an area A1 within the effective sealing diameter of the first dry gas seal 1221 is equal to an area A2 within the effective sealing diameter of the second dry gas seal 1222, and when it is assumed that the axial thrust force generated by the first dry gas seal 1221 and the second dry gas seal 1222 is F, F is generated by the following Equation (1).

F=(P1−P2)×A1 Equation (1)

However, since the area A1 within the effective sealing diameter of the first dry gas seal 1221 is different from the area A2 within the effective sealing diameter of the second dry gas seal 1222, the axial thrust force may be influenced by a pressure P12 of a space S12 sealed by the second dry gas seal 1222. Therefore, when it is assumed that the axial thrust force generated by the first dry gas seal 1221 and the second dry gas seal 1222 having different effective sealing diameters is F1, F1 is generated by the following Equation (2).

F1=(P1−P2)×A1−(A1−A2)×P12 Equation (2)

In a structure of the IGC, a pressure in the space S12 may be adjusted. Therefore, an axial thrust force F1 generated by the first dry gas seal 1221 and the second dry gas seal 1222 may be adjusted by adjusting P12.

Similarly, in the second sealing device 22, the axial thrust force may be adjusted. An axial thrust force of the case in which the second sealing device 22 may include the tandem dry gas seals including a third dry gas seal which firstly blocks the gas and a fourth dry gas seal which secondarily blocks the gas.

A pressure in a space sealed by the third dry gas seal is referred to as P3. A pressure in a space sealed by the fourth dry gas seal is referred to as P34. A pressure in a space separated from the sealed space by the fourth dry gas seal is referred to as P4. An area within an effective sealing diameter of the third dry gas seal is referred to as A3. Finally, an area within an effective sealing diameter of the fourth dry gas seal is referred to as A4.

When the effective sealing diameters of the third dry gas seal and the fourth dry gas seal are different, and when it is assumed that the axial thrust force generated by the third dry gas seal and the fourth dry gas seal is F2, F2 is generated by the following Equation (3).

F2=(P3−P4)×A3−(A3−A4)×P34 Equation (3)

In summary, the axial thrust force F1 generated by the first dry gas seal and the second dry gas seal is changed according to the pressure P12 in the space sealed by the second dry gas seal, and the axial thrust force F2 generated by the third dry gas seal and the fourth dry gas seal is changed according to the pressure P34 in the space sealed by the fourth dry gas seal. Therefore, the axial thrust force acting on the rotor may be balanced in two opposite directions by appropriately adjusting P12 and P34.

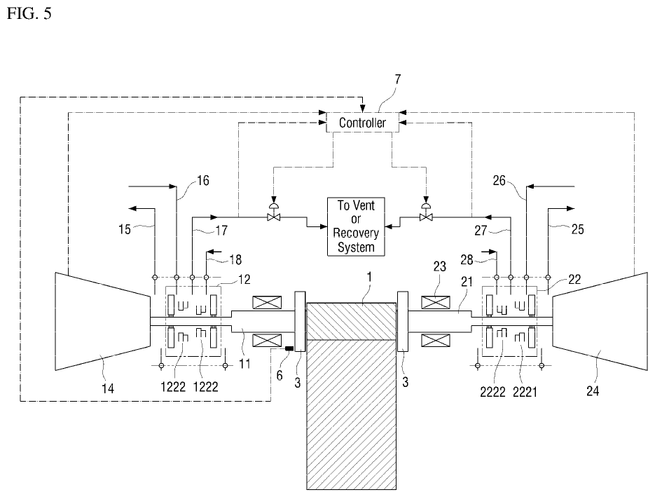

Based on the principle of balancing the axial thrust force acting on the rotor in two opposite directions as described above, a system for balancing an axial thrust force acting on a rotor in two opposite directions will be described with reference to the IGC illustrated in FIG. 5 according to an example embodiment.

In the first sealing device 12, the effective sealing diameter of the first dry gas seal 1221 may be greater than the effective sealing diameter of the second dry gas seal 1222. The effective sealing diameter of the second dry gas seal 1222 may be greater than the effective sealing diameter of the first dry gas seal 1221. However, in consideration of the axial thrust force applied to the pinion gear 1 by the first-stage compression unit 14, making the effective sealing diameter of the first dry gas seal 1221 greater than the effective sealing diameter of the second dry gas seal 1222 is more effective for balancing the axial thrust force.

Also, in the second sealing device 22, the effective sealing diameter of the third dry gas seal 2221 may be greater than the effective sealing diameter of the fourth dry gas seal 2222, which is more effective for balancing the axial thrust force.

Further, the first dry gas seal 1221 of the first sealing device 12 and the third dry gas seal 2221 of the second sealing device 22 may be configured to have the same effective sealing diameter, and the second dry gas seal 1222 of the first sealing device 12 and the fourth dry gas seal 2222 of the second sealing device 22 may be configured to have the same effective sealing diameter. However, example embodiments are not limited thereto, and in consideration of operation maps of the first-stage compression unit 14 and the second-stage compression unit 24, the design of the first sealing device 12 and the second sealing device 22 may be changed so the first sealing device 12 and the second sealing device 22 are not symmetrical.

Referring to FIG. 5, a sensor 6 is configured to measure an axial position of the rotor of the IGC. The sensor 6 may measure an axial position of any one of two thrust collars 3 located at two opposite sides of the pinion gear 1 to measure the axial position of the rotor. However, example embodiments are not limited thereto, and the sensor 6 may be configured to measure the axial position of the rotor on the basis of the other components of the rotor.

A control device 7 is configured to adjust, on the basis of the axial position of the rotor measured by the sensor 6, a pressure in a space between the tandem seals 1221 and 1222 of the first sealing device and a pressure in a space between the tandem seals 2221 and 2222 of the second sealing device using a first port 17 connected to the space sealed by the second dry gas seal 1222 and a second port 27 connected to the space sealed by the fourth dry gas seal 2222.

Further, the control device 7 may be configured to independently control the pressure in the space between the tandem seals 1221 and 1222 of the first sealing device and the pressure in the space between the tandem seals 2221 and 2222 of the second sealing device by independently controlling the first port 17 and the second port 27.

In addition, the control device 7 may be configured to control reference ports 15 and 25 for monitoring supply of a dry gas seal for pipe control efficiency, sealing gas ports 16 and 26 for the dry gas seal, and separation ports 18 and 28 for supplying a separation gas.

According to example embodiments, the tandem seals of the first sealing device 12 and the second sealing device 22 are configured as two dry gas seals. However, example embodiments are not limited thereto, and a greater number of dry gas seals than the two dry gas seals may be configured. Alternatively, the tandem seals of the first sealing device 12 and the second sealing device 22 may be configured as labyrinth seals or floating seals which are different from the dry gas seals.

According to example embodiments of the present disclosure, an axial thrust force acting on a rotor in an IGC may be adjusted in two opposite directions of a gear. Therefore, a thrust force generated in compressors located at two opposite sides of a gear can be more effectively offset. Furthermore, since the thrust load acting on the rotor in the IGC is offset, an operating pressure level at which the IGC operates may be increased.

The effects according to the present disclosure are not limited by the above-exemplified contents and more various effects are included in this specification.

It will be understood by those skilled in the art that the disclosure may be performed in other concrete forms without changing the technological scope and essential features. Therefore, the above-described example embodiments should be considered in a descriptive sense only and not for purposes of limitation. The scope of the present disclosure is defined not by the detailed description but by the appended claims, and encompasses all modifications and alterations derived from meanings, the scope and equivalents of the appended claims.

What is claimed is:

1. An axial thrust force balancing apparatus for a compressor comprising:
a rotor comprising:
a pinion gear configured to receive rotational power from a bull gear;
a first shaft disposed at one side of the pinion gear and configured to communicate with the pinion gear;
a second shaft disposed at the other side of the pinion gear and configured to communicate with the pinion gear;
a first rotating body disposed at one end of the first shaft and configured to communicate with the first shaft; and
a second rotating body disposed at one end of the second shaft and configured to communicate with the second shaft;
a first sealing device comprising tandem seals configured to surround the first shaft in a radial direction;
a second sealing device comprising tandem seals configured to surround the second shaft in a radial direction; and
a control device configured to adjust a pressure in a space between the tandem seals of the first sealing device and a pressure in a space between the tandem seals of the second sealing device, and balance an axial thrust force acting on the rotor in two opposite directions.

2. The axial thrust force balancing apparatus of claim 1, wherein the control device is further configured to adjust the pressure in the space between the tandem seals of the first sealing device and the pressure in the space between the tandem seals of the second sealing device based on an axial position of the rotor.

3. The axial thrust force balancing apparatus of claim 2, further comprising a sensor configured to measure the axial position of the rotor.

4. The axial thrust force balancing apparatus of claim 3, further comprising two thrust collars disposed at two opposite sides of the pinion gear and respectively disposed adjacent to the first shaft and the second shaft,
wherein the sensor is further configured to measure an axial position of any one of the two thrust collars, and measure the axial position of the rotor based on the measured axial position of any one of the two thrust collars.

5. The axial thrust force balancing apparatus of claim 1, wherein the control device is further configured to independently adjust the pressure in the space between the tandem seals of the first sealing device and the pressure in the space between the tandem seals of the second sealing device.

6. The axial thrust force balancing apparatus of claim 1, wherein the tandem seals of the first sealing device are configured as tandem seals with different effective sealing diameters, and the tandem seals of the second sealing device are configured as tandem seals with different effective sealing diameters.

7. The axial thrust force balancing apparatus of claim 6, wherein the first sealing device and the second sealing device comprise the same number of seals.

8. The axial thrust force balancing apparatus of claim 6, wherein the seals included in the first sealing device and the second sealing device, respectively, comprise a rotating part and a non-rotating part, and
wherein the rotating part comprises a groove configured to compress gas and maintain a gap between the rotating part and the non-rotating part.

9. The axial thrust force balancing apparatus of claim 1, wherein the tandem seals of the first sealing device comprise a first seal configured to firstly seal process gas introduced from the first rotating body and a second seal configured to secondarily seal the process gas, and
wherein the tandem seals of the second sealing device comprise a third seal configured to firstly seal process gas introduced from the second rotating body and a fourth seal configured to secondarily seal the process gas.

10. The axial thrust force balancing apparatus of claim 9, wherein an effective sealing diameter of the first seal is different from an effective sealing diameter of the second seal, and an effective sealing diameter of the third seal is different from an effective sealing diameter of the fourth seal.

11. The axial thrust force balancing apparatus of claim 10, wherein the effective sealing diameter of the first seal is greater than the effective sealing diameter of the second seal, and the effective sealing diameter of the third seal is greater than the effective sealing diameter of the fourth seal.

12. The axial thrust force balancing apparatus of claim 11, wherein the effective sealing diameter of the first seal is equal to the effective sealing diameter of the third seal, and the effective sealing diameter of the second seal is equal to the effective sealing diameter of the fourth seal.

13. The axial thrust force balancing apparatus of claim 9, wherein the control device is further configured to adjust a pressure in a space between the first seal and the second seal and a pressure in a space between the third seal and the fourth seal.

14. The axial thrust force balancing apparatus of claim 13, wherein the control device is further configured to independently adjust the pressure in the space between the first seal and the second seal and the pressure in the space between the third seal and the fourth seal.

15. The axial thrust force balancing apparatus of claim 13, wherein:
a first axial thrust force F1 is formed according to F1=(P1−P2)×A1−(A1−A2)×P12,
where A1 is an area within an effective sealing diameter of the first seal,
A2 is an area within an effective sealing diameter of the second seal,
P1 is a pressure in a space sealed by the first seal,
P12 is a pressure in a space sealed by the second seal, and
P2 is a pressure in a space separated from the sealed space by the second seal;
a second axial thrust force F2 is formed according to F2=(P3−P4)×A3−(A3−A4)×P34,
where A3 is an area within an effective sealing diameter of the third seal,
A4 is an area within an effective sealing diameter of the fourth seal,
P3 is a pressure in a space sealed by the third seal,
P34 is a pressure in a space sealed by the fourth seal, and
P4 is a pressure in a space separated from the sealed space by the fourth sea,
wherein the control device is configured to adjust P12 and P34 and adjust F1 and F2 based on the adjusted P12 and P34.

16. The axial thrust force balancing apparatus of claim 1, wherein each of the first sealing device and the second sealing device is configured as at least one of a dry gas seal, a labyrinth seal, and a floating seal.

17. The axial thrust force balancing apparatus of claim 1, wherein the rotor further comprises a first stage compressor disposed at one end of the first rotating body and a second stage compressor disposed at one end of the second rotating body, and
wherein the control device is further configured to balance the axial thrust force acting on the rotor in two opposite directions by the first stage compressor and the second stage compressor.
